(19) United States
(12) Patent Application Publication
(10) Pub. No.: US 2007/0060082 A1
(43) Pub. Date: Mar. 15, 2007

(54) Receiving apparatus

(76) Inventors: Nobuyoshi Okumura, Tokyo (JP); Masayuki Ishida, Tokyo (JP); Kenichi Taura, Tokyo (JP); Tadatoshi Ohkubo, Tokyo (JP)

Correspondence Address: BIRCH STEWART KOLASCH & BIRCH, PO BOX 747, FALLS CHURCH, VA, 22040-0747, US

(21) Appl. No.: 10/573,981

(22) PCT Filed: Jun. 6, 2005
(86) PCT No.: PCT/JP05/10371

§ 371 Date: Mar. 30, 2006

(30) Foreign Application Priority Data
Aug. 27, 2004 (JP) 2004-248890

(51) Int. Cl. H04B 1/18

(52) U.S. Cl. 455/179.1

(57) ABSTRACT

A receiving apparatus 10 receives a broadcasting wave to which service information indicating at least a channel number, a transmission broadcasting station name, and a broadcast target area are added. A control CPU 20 controls a tuner 11 so as to determine whether the broadcasting wave can be received in a predetermined region while changing the channel number, extracts the service information added to the broadcasting wave which is determined to be able to be received thereby, and registers the service information, as preset information, into one preset group in a memory 19. The control CPU then controls the tuner according to the preset information registered into the preset group so as to select the broadcasting wave.

### FIELD OF THE INVENTION

The present invention relates to a receiving apparatus for use in a moving object such as a vehicle. More particularly, it relates to a receiving apparatus having a preset function of automatically selecting a digital broadcast.

### BACKGROUND OF THE INVENTION

In general, such a receiving apparatus allows the user to select a desired broadcasting wave when receiving a television broadcast or radio broadcast. There have been provided receiving apparatus having a preset function of allowing the user to register a broadcasting station which transmits the desired broadcasting wave (or a transmission frequency) into the receiving apparatus.

As a receiving apparatus having the above-mentioned preset function, there has been provided a receiving apparatus (for example, refer to patent reference 1) having two or more channel selecting means each for outputting channel selection information for specifying a television broadcast, and for storing two or more TV setting information files each having channel information data associating a channel selection number identifying a corresponding one of the plurality of channel selection means with a channel number specifying a television broadcast, so as to enable the user to easily select a desired television broadcast even if the number of channels increases.

By the way, in a vehicle-mounted receiving apparatus mounted in a moving object such as a vehicle, since receivable broadcasting stations change as the vehicle travels (i.e., since the receivable broadcasting stations differ according to an area in which the vehicle is currently located), even if the user presets receivable broadcasting stations as receivable broadcasting station information in advance, the user needs to preset receivable broadcasting stations again, or preset receivable broadcasting station information for every area when the receivable broadcasting stations change as the vehicle travels, and to select a desired broadcast according to the receivable broadcasting station information which is preset for every area.

On the other hand, there has been provided a vehicle-mounted receiving apparatus (for example, refer to patent reference 2) having two or more groups in each of which predetermined frequencies transmitted by arbitrary broadcasting stations are stored while being associated with a plurality of channels, respectively, in order to easily set frequencies for radio broadcasting which are corresponding to a specific area when a vehicle in which the receiving apparatus is mounted moves to the area, identification codes different according to areas being assigned to the plurality of groups, respectively, for, when the vehicle moves to a different area, selecting a group including channels having stored frequencies which are corresponding to the area.

[Patent reference 1] JP,2003-23576,A (see pages 3 to 5 and FIGS. 2 to 4)

[Patent reference 2] JP,6-291611,A (see pages 3 and 4 and FIGS. 1 and 2)

In related art receiving apparatus constructed as mentioned above, such as a vehicle-mounted receiving apparatus, since receivable broadcasting stations change as the vehicle moves, information about the receivable broadcasting stations must be preset as preset information for every area.

A problem with such related art receiving apparatus is therefore that in a case where preset information is stored for every area, since the user has to select a desired broadcast by retrieving preset information corresponding to an area in which the vehicle is currently traveling, the user has to perform a burdensome procedure of determining in which area the vehicle is currently traveling to select preset information corresponding to the area and therefore the user cannot easily select a receivable broadcasting station according to the area in which the vehicle is currently traveling.

Furthermore, a problem with the related art vehicle-mounted receiving apparatus having two or more groups in each of which predetermined frequencies transmitted by arbitrary broadcasting stations are stored while being associated with a plurality of channels, respectively, identification codes different according to areas being assigned to the plurality of groups, respectively, is that every time when the vehicle moves a different area, the user has to cause the receiving apparatus to retrieve information about broadcasting stations corresponding to the area according to the identification code associated with the area, and therefore the user cannot easily select a receivable broadcasting station according to the area in which the user is currently located.

A further problem is that the user has to perform a very burdensome procedure of presetting receivable broadcasting stations in a memory while associating them with every area.

The present invention is made in order to solve the above-mentioned problems, and it is therefore an object of the present invention to provide a receiving apparatus which enables the user to extremely easily preset receivable broadcasting stations for every area and which enables the user to easily select a receivable broadcasting station according to an area in which the user is currently located.

### DISCLOSURE OF THE INVENTION

A receiving apparatus in accordance with the present invention receives a broadcasting wave to which service information indicating at least a channel number, a transmission broadcasting station name, and a broadcast target area are added. The receiving apparatus includes a reception determining means for determining whether the broadcasting wave can be received in a predetermined region while changing the channel number, and a registration means for extracting the service information added to the broadcasting wave which is determined to be able to be received by the reception determining means, and for registering the service information, as preset information, into one preset group. A channel selecting means selects the broadcasting wave according to the preset information registered into the preset group.

The receiving apparatus according to the present invention is so constructed as to determine whether a broadcasting wave can be received in a predetermined region while changing the channel number, and, after extracting the service information added to the broadcasting wave which is determined to be able to be received, and then registering the service information, as preset information, into one preset group, selects the broadcasting wave according to the preset information registered into the preset group. Therefore, the present invention offers an advantage of being to able to enable the user to extremely easily preset receivable broadcasting stations for each area and to enable the user to easily select a receivable broadcasting station according to an area in which the receiving apparatus is currently located.

### BRIEF DESCRIPTION OF THE FIGURES

FIG. 1 is a block diagram showing an example of the structure of a receiving apparatus in accordance with embodiment 1 of the present invention;

FIG. 2 is a block diagram for explaining the operation of a control CPU for use in the receiving apparatus shown in FIG. 1;

FIG. 3 is a flow chart for explaining an example of the operation of the receiving apparatus shown in FIG. 1;

FIG. 4 is a block diagram for explaining the operation of the control CPU for use in the receiving apparatus shown in FIG. 1;

FIG. 5 is a diagram showing examples of a preset group, and FIGS. 5 (a) and 5(b) are diagrams showing different preset groups;

FIG. 6 is a block diagram for explaining reception of selection of a group from a preset group list in the receiving apparatus shown in FIG. 1;

FIG. 7 is a diagram showing an example of a preset group list screen;

FIG. 8 is a diagram showing a preset group screen corresponding to a preset group number selected from the preset group list screen;

FIG. 9 is a diagram for explaining a selection of a channel corresponding to a one-touch button number selected from the preset group screen according to a remote controller input;

FIG. 10 is a flow chart for explaining the operation of a receiving apparatus in accordance with embodiment 2 of the present invention; and

FIG. 11 is a block diagram for explaining the operation of a control CPU in the receiving apparatus in accordance with embodiment 2 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

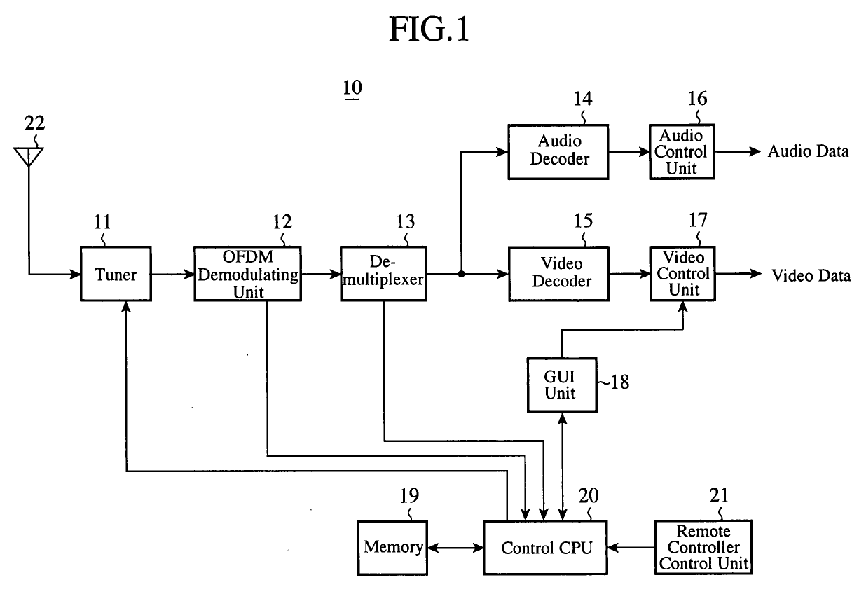

FIG. 1 is a block diagram showing a receiving apparatus in accordance with embodiment 1 of the present invention, and the shown receiving apparatus is so constructed as to receive a digital broadcast using a ground wave (referred to as a ground digital broadcast from here on) which enables reception of the ground digital broadcast.

In the ground digital broadcasting, a broadcasting station is disposed for each broadcast area, and ground-digital-broadcasting waves are transmitted from these broadcasting stations (in the ground digital broadcasting, an OFDM (Orthogonal Frequency Division Multiplexing) method is used). Therefore, when receiving a ground-digital-broadcasting wave, a receiving apparatus mounted in a moving object, such as a vehicle, needs to select a receivable broadcasting station every time receivable broadcasting stations change as an area (i.e., a broadcast area) in which the moving object is traveling changes according to the travel of the moving object.

On the other hand, a ground-digital-broadcasting wave includes a digital video signal, a digital voice signal, and service information (Service_Information: SI information), and the SI information includes data indicating a transmission channel (or a transmission frequency), a transmission broadcasting station's name, a broadcast target area (or a broadcast area), a program, etc.

As shown in FIG. 1, the receiving apparatus 10 is provided with a tuner 11, an orthogonal frequency division multiplex (OFDM) demodulating unit 12, a demultiplexer 13, an audio decoder 14, a video decoder 15, an audio control unit 16, a video control unit 17, a GUI (Graphic User Interface) unit 18, a memory 19, and a control CPU 20 and a remote controller control unit 21. When receiving a ground-digital-broadcasting wave (simply referred to as a broadcasting wave from here on) associated with a channel selected by the tuner 11 via an antenna 22, the tuner 11 extracts a component of the same frequency as that of the ground-digital-broadcasting wave, the OFDM demodulating unit 12 demodulates the frequency component to generate a digital signal and provides it to the demultiplexer 13 as a transport stream.

The demultiplexer 13 separates an audio stream, a video stream, and SI information from the transport stream, and provides the audio stream, video stream, and SI information to the audio decoder 14, video decoder 15, and control CPU 20, respectively. The audio decoder 14 decodes the audio stream and provides it, as an audio decoded signal, to the audio control unit 16. The audio control unit 16 then outputs the audio decoded signal as an analog audio signal.

Similarly, the video decoder 15 decodes the video stream and provides it, as a video decoded signal, to the video control unit 17. The video control unit 17 then converts the video decoded signal into an analog video signal. On the other hand, the control CPU 20 extracts program information from the SI information, and delivers this program information to the GUI unit 18. The GUI unit 18 generates a program table according to the program information, for example, and provides this program table to the video control unit 17. The video control unit 17 combines the above-mentioned analog video signal and the above-mentioned program table, and outputs them as a composite signal.

The control CPU 20 temporarily stores data indicating a transmission channel, a transmission broadcasting station's name (i.e., a transport stream name), and a broadcast area, which are extracted from the SI information, in the memory 19.

When the user manipulates a remote controller (not shown), the remote controller control unit 21 provide a corresponding command to the control CPU 20, and the control CPU 20 controls the tuner 11 and GUI unit 18 according to the command so as to cause the tuner 11 to select a broadcasting station, and to generate a program table using the GUI unit 18, as mentioned above (and also generate a menu screen display by using the GUI unit 18).

By the way, the shown receiving apparatus 10 has a preset function, and, as will be mentioned later, stores information about receivable broadcasting stations in each area, as preset information, in the memory 19 by using this preset function. The control CPU then controls the tuner to cause the tuner to select a broadcasting station according to the preset information stored in the memory 19.

Next, the operation of the receiving apparatus in accordance with this embodiment of the present invention will be explained.

Referring now to FIGS. 1 to 3, the control CPU 20 monitors whether or not a command is delivered thereto from the remote controller control unit 21, and, when receiving a command from the remote controller control unit 21 (there is a remote controller input in step ST1), the control CPU 20 determines whether this command indicates a channel scanning start by means of a channel scanning start judging unit 20a (in step ST2). When determining that the command does not indicate a channel scanning start, the control CPU 20 carries out processing indicated by the input command (other processing in step ST3).

The above-mentioned command is delivered to the remote controller control unit from the remote controller or a menu screen. In order to start a channel scanning, the user pushes a channel scanning button disposed in the remote controller, for example. As an alternative, the user can select a channel scanning start button shown in the menu screen.

On the other hand, when the channel scanning start judging unit 20a, in step ST3, judges that the command indicates a channel scanning start, as shown in FIG. 3, a tuner frequency control unit 20b controls the tuner 11 so as to change the channel to UHF 13ch, for example (in step ST4). The control CPU 20 then determines whether a transport stream is obtained from the OFDM demodulating unit 12 within a predetermined time period (i.e., a fixed time period) by means of a receivable-or-unreceivable judging unit 20c (in step ST5).

When, in step ST5, obtaining a transport stream within the predetermined time period, the receivable-or-unreceivable judging unit 20c determines that a ground-digital-broadcasting wave can be received via that channel (in this case, UHF 13ch), and the control CPU extracts a transport stream name, a transport stream number (TS_id), a remote controller number (remote_control_key_id), and a broadcast target area number (service_id) from NIT (Network_Information_Table) included in the SI information provided from the demultiplexer 13 (SI information acquisition in step ST6).

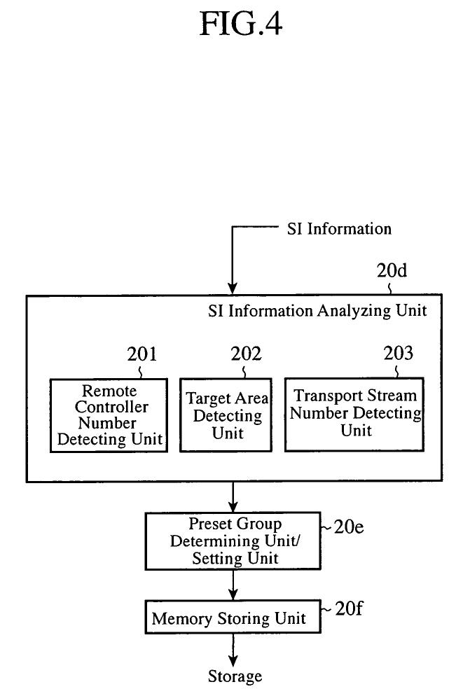

As shown in FIG. 4, the control CPU 20 is provided with an SI information analyzing unit 20d, a preset group determining unit/setting unit 20e, and a memory storing unit 20f, and the SI information analyzing unit 20d includes a remote controller number (remote_control_key_id) detecting unit 201, a target area (service_id) detecting unit 202, and a transport stream number (TS_id) detecting unit 203. The above-mentioned remote_control_key_id indicates a one-touch button number which is one of the buttons “1”, . . . , and “12” of the remote controller, and the remote controller number detecting unit 201 detects a one-touch number according to the remote_control_key_id.

Similarly, the target area detecting unit 202 detects a broadcast target area (for example, the name of one of Tokyo, Hokkaido and all the Prefectures of Japan) from service_id, and the transport stream number detecting unit 203 detects a transport stream number, and, for the channel UHF 13ch, assigns the transport stream name and transport stream id to the one-touch button number indicated by the remote_control_key_id, and also assigns the broadcast target area to the one-touch button number, so as to set them as first preset information.

Thus, after determining the first preset information about the channel UHF 13ch, the control CPU 20 determines whether it has already completed the scanning associated with up to the last channel. In this case, since the control CPU 20 performs the scanning associated with channels starting from the channel UHF 13ch and ending at the channel UHF 62ch one by one, for example, the control CPU 20 determines whether it has already completed the scanning associated with up to the channel UHF 62ch (in step ST7).

When the control CPU 20, in step ST7, determines that it has already completed the scanning associated with up to the channel UHF 62ch, the control CPU 20 controls the tuner 11 to increment the channel number by 1 by using the tuner frequency control unit 20b (in step ST8), and then returns to step ST5. When the receivable-or-unreceivable judging unit 20c, in step ST5, determines that no transport stream has been obtained within the predetermined time period, the control CPU 20 shifts from step ST5 to step ST7.

When the control CPU has completed the scanning associated with all the channels starting from the channel UHF 13ch and ending at the channel UHF 62ch in the above-mentioned way, the preset group determining unit/setting unit 20e provides a preset number n (n is an integer which is equal to or larger than 1) to the preset information about one preset group including the channels starting from the channel UHF 13ch and ending at the channel UHF 62ch so as to set up the preset group. The memory storing unit 20f then registers the preset information about this preset group into the memory 19 (registration of preset information into n in step ST9).

When the channel scanning is carried out for the first time and the preset information is thus acquired, the preset group number is set to n=1. After that, every time when the channel scanning is carried out, the preset group number n is incremented by 1.

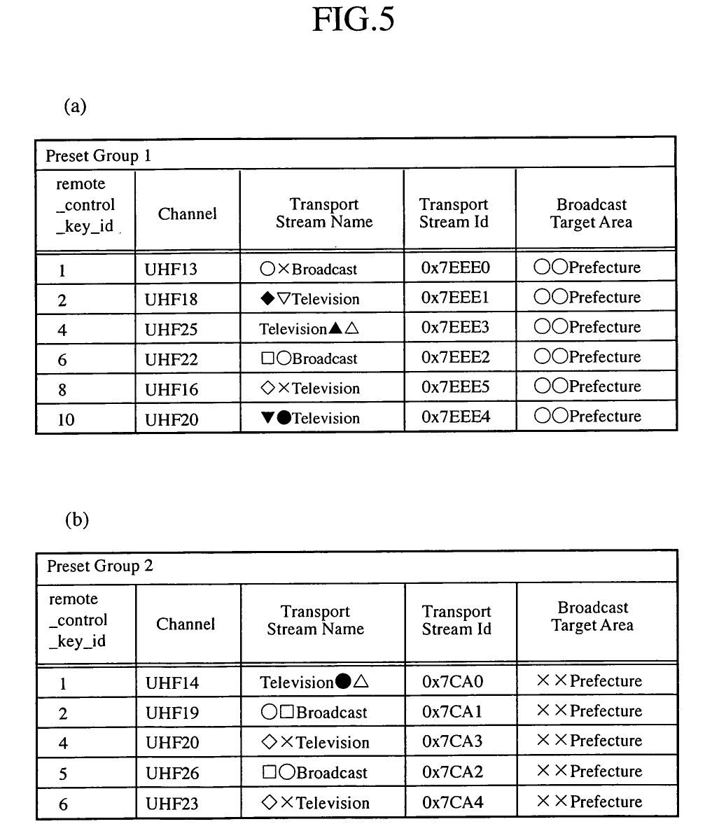

FIG. 5 is a diagram showing an example of preset groups registered into the memory 19, FIG. 5(a) shows preset information belonging to a preset group 1, and FIG. 5(b) shows preset information belonging to a preset group 2. Thus, every time when the vehicle moves to a different area according to its travel, the channel scanning can be carried out and a preset group can be registered into the memory 19.

Information about any preset group which is registered into the memory 19, as mentioned above, can be read from the memory 19 as follows.

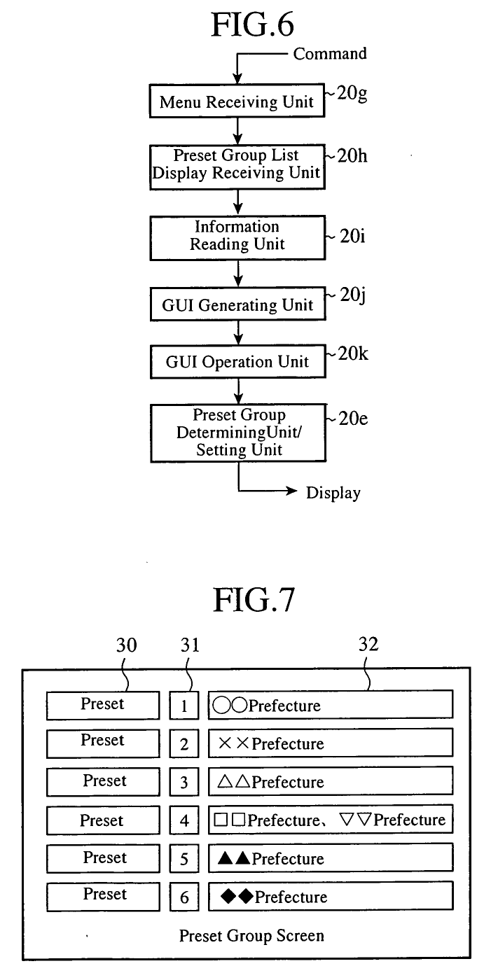

Referring now to FIG. 6, when receiving a preset group list display command from a menu screen (not shown) by using a menu receiving unit 20g, the control CPU 20 delivers the preset group list display command to a preset group list display receiving unit 20h so that an information reading units 20i can access the memory 19 to read information about the preset group. A GUI generating unit 20j generates a preset group list and then delivers the preset group list to the GUI unit 18 (shown in FIG. 1), and the GUI unit 18 displays the preset group list on the screen of a display by way of the video control unit 17.

FIG. 7 is a diagram showing an example of the preset group list screen display. When the user selects a desired preset group from the preset group list displayed on the screen, a GUI operation receiving unit 20k receives this selection, and the preset group determining unit/setting unit 20e reads preset information corresponding to the selected preset group from the memory 19, and then generates a preset group screen display by way of the GUI unit 18.

As shown in FIG. 7, in the preset group list screen display, numbers (i.e., preset group numbers indicated by a reference numeral 31) for identifying presettings are shown while being associated with the presettings (i.e., plural pieces of preset information) 30, respectively, and broadcast target areas (indicated by a reference numeral 32) are also shown while being associated with the presettings, respectively. When the user selects a desired preset group number from this preset group list screen display, and pushes a corresponding numeric button of the remote controller, the control CPU 20 selects a preset group corresponding to the desired preset group number shown in the preset group list screen display.

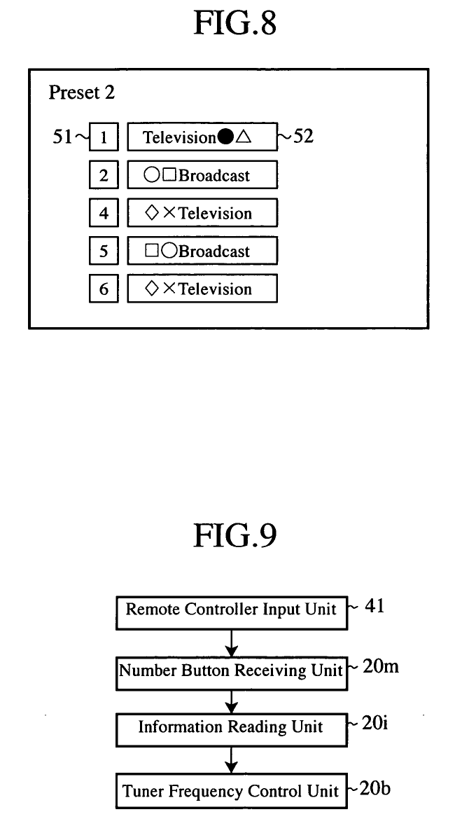

When the control CPU 20 selects a preset group, for example, when the preset group number “2” is selected in FIG. 7, the control CPU 20 generates a preset group screen display corresponding to the preset group number “2” (preset “2”) by way of the GUI unit 18 and video control unit 17. FIG. 8 is a diagram showing an example of the preset group screen display corresponding to the preset “2”. In this preset group screen display, broadcasting station names (indicated by a reference numeral 52) are displayed while being associated with one-touch button numbers (indicated by a reference numeral 51), respectively. The user can select one broadcasting station based on a correspondence between the one-touch button numbers and the broadcasting station names, which is registered into the preset group, while seeing the preset group screen.

Referring to FIG. 9, when a one-touch button number is delivered from a remote controller input unit 41, the control CPU 20 receives the one-touch button number by using a numeric button receiving unit 20m. Then, based on the correspondence between the one-touch button numbers and the broadcasting station names which is registered into the selected preset group, the information reading unit 20i accesses the memory 19 so as to obtain a corresponding channel number. The control CPU 20 then controls the tuner 11 (shown in FIG. 1) by using the tuner frequency control unit 20b so as to cause the tuner 11 to select a ground-digital-broadcasting wave corresponding to the channel number.

For example, in a case where the user has been staying in an xx prefecture and has already selected the preset group number “2” in the preset group list shown in FIG. 7, when the user pushes the one-touch button number “4” of the remote controller, the tuner 11 selects the channel UHF 20ch corresponding to the remote_control_key_id of “4” according to the above-mentioned procedure, so as to select a transport stream id: 0x7CA3 and a transport stream name: <>x television, as shown in FIG. 5(b).

As can be seen from the above explanation, the channel scanning start judging unit 20a, tuner frequency control unit 20b, and receivable-or-unreceivable judging unit 20c collectively function as a reception determining means, and the SI information analyzing unit 20d, preset group determining unit/setting unit 20e, and memory storing unit 20f collectively function as a registration means. Furthermore, the remote controller input unit 41, numeric button receiving unit 20m, information reading unit 20i, and tuner frequency control unit 20b collectively function as a channel selecting means. In addition, the menu receiving unit 20g, preset group list display receiving unit 20h, information reading unit 20i, and GUI generating unit 20j collectively function as a display control means.

Thus, since the receiving apparatus displays a preset group list when the user selects a display of the list from a menu screen, and, when the user selects a desired preset group number from this preset group list, displays one-touch button numbers associated with transport streams registered into the selected preset group with the one-touch button numbers being linked to the corresponding broadcast target area, the user can easily select a preset number (i.e., a one-touch button number) from preset numbers assigned to the broadcast target area in which the vehicle is currently located.

As mentioned above, when carrying out a channel scanning start, the receiving apparatus according to this embodiment 1 determines whether it can receive a broadcasting wave while changing the channel number, extracts SI information added to a broadcasting wave which is determined to be able to be received, and registers this SI information, as preset information, into one preset group, and selects a broadcasting wave according to the preset information registered into the preset group, the receiving apparatus can carry out presetting of broadcasting waves which it can receive for each area very easily and can easily select a receivable broadcasting wave according to an area in which the vehicle is currently located.

The receiving apparatus according to this embodiment 1 registers a remote_control_key_id and a transport stream id which are included in the SI information while associating them with each other, and, when a preset group list showing a list of preset groups is displayed and the user selects one preset group from this preset group list, generates a preset group screen display in which the broadcast target area associated with this selected preset group is associated with remote_control_key_ids. The present embodiment therefore offers an advantage of being able to enable the user to easily select a receivable broadcasting wave according to the current position of the vehicle, and being able to receive a broadcasting wave of a desired channel number by selecting one remote_control_key_id which is associated with the broadcast target area in which the vehicle is currently located.

According to this embodiment 1, when remote_control_key_id is input, the receiving apparatus selects a channel number according to both the input remote_control_key_id and a preset group number indicating the selected preset group displayed on the preset group screen. Therefore, the present embodiment offers another advantage of being able to receive a desired broadcasting wave very easily.

### Embodiment 2

The receiving apparatus in accordance with above-mentioned embodiment 1 generates a screen display showing a preset group list, and enables the user to select a desired preset number according to the current position of the vehicle and a broadcast target area in which the vehicle is currently located. In contrast, a receiving apparatus in accordance with this embodiment scans channel numbers one by one and selects a channel number by using a control CPU when the user pushes a search button disposed in a remote controller.

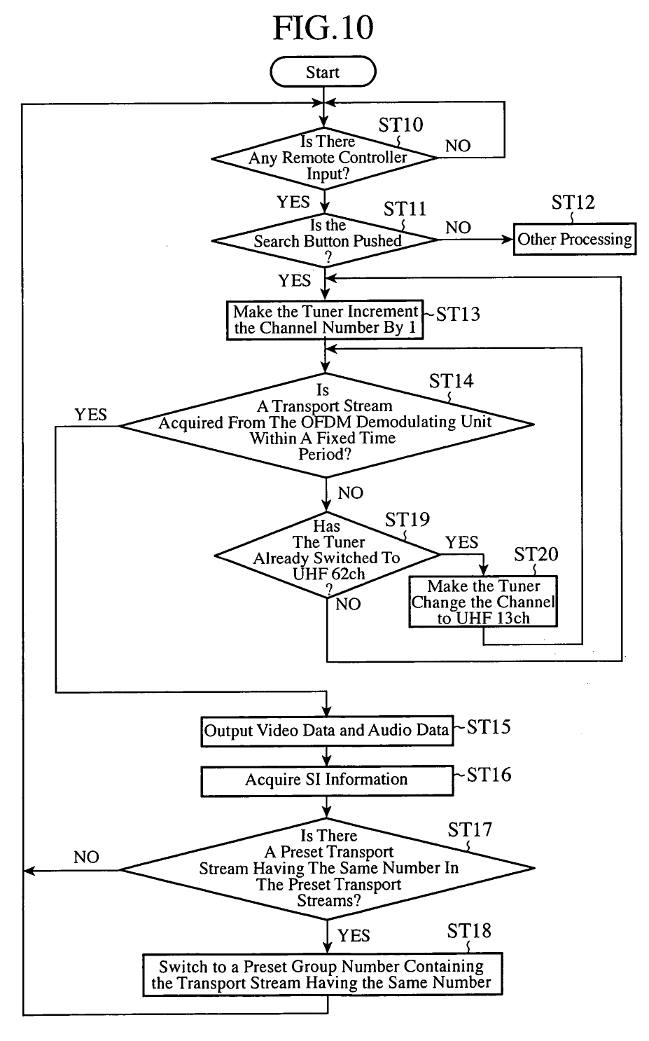

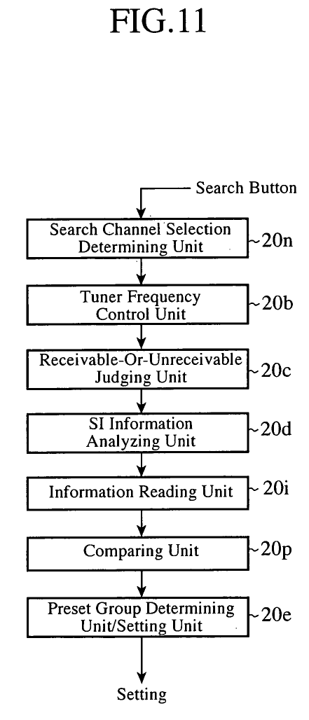

Referring now to FIGS. 10 and 11, the control CPU 20 monitors whether or not a command is delivered thereto from a remote controller control unit 21, and, when receiving a command from the remote controller control unit 21 (there is a remote controller input in step ST10), the control CPU 20 determines whether this command indicates that the search button of the remote controller is pushed by using a search channel selection determining unit 20n shown in FIG. 11 (in step ST11). When the search channel selection determining unit determines that the search button is not pushed, the control CPU 20 carries out processing indicated by the input command (other processing in step ST12).

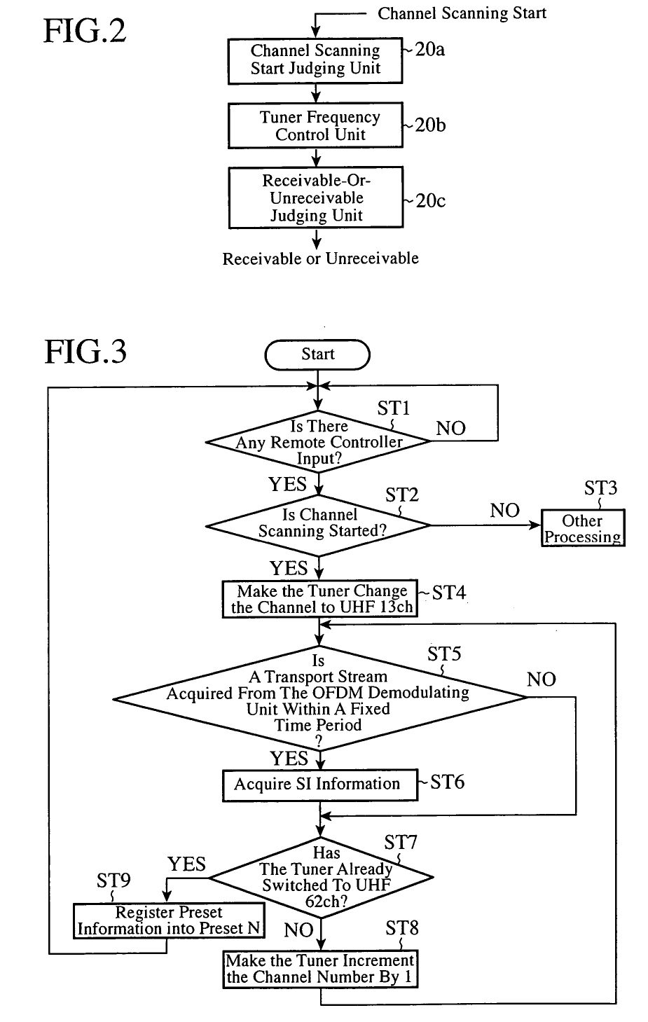

On the other hand, when the search channel selection determining unit 20n, in step ST11, determines that the search button is pushed, a tuner frequency control unit 20b controls a tuner 11 so as to cause the tuner 11 to increment the current channel by 1 (in step ST13), and the control CPU 20 then determines whether a transport stream is obtained from an OFDM a demodulating unit 12 within a predetermined time period (i.e., a fixed time period) by means of a receivable-or-unreceivable judging unit 20c shown in FIG. 2 (in step ST14).

When a transport stream is obtained, in step ST14, the receivable-or-unreceivable judging unit 20c determines that a ground-digital-broadcasting wave can be received via the channel. Then, as mentioned above, an analog audio signal and an analog video signal are outputted from an audio control unit 16 and a video control unit 17, respectively (output of image and sound in step ST15).

The control CPU then extracts a transport stream name, a transport stream number (TS_id), a remote controller number (remote_control_key_id), and a broadcast target area number (service_id) from NIT (Network_Information_Table) included in SI information provided from a demultiplexer 13 (SI information acquisition in step ST16).

An SI information analyzing unit 20d detects a broadcast target area (for example, the name of one of Tokyo, Hokkaido and all the Prefectures of Japan) from service_id by using a target area detecting unit 202 (refer to FIG. 4), and accesses the memory 19 to read information about a corresponding preset group by using an information reading unit 20i. A comparing unit 20p then compares the broadcast target area associated with the preset group with a broadcast target area associated with the transport stream currently being received. A preset group determining unit/setting unit 20e registers the transport stream currently being received into the corresponding preset group according to the result of the comparison.

The control CPU 20 further determines whether a preset transport stream having the same TS_id exists (in step ST17), and, when determining that a transport stream having the same TS_id exists, switches to a preset group number containing this transport stream (in step ST18).

On the other hand, when, in step ST14, determining with no transport stream is acquired, the control CPU 20 determines whether or not the last channel (e.g., a channel UHF 62ch) is set to the tuner 11 (in step ST19). When, in step ST19, determining that the channel 62ch is not set to the tuner 11, the control CPU controls the tuner 11 so as to set a channel UHF13ch to the tuner 11 by using the tuner frequency control unit 20b (in step ST20). The control CPU 20 then returns to step ST14 in which it continues the processing.

On the other hand, when, in step ST19, determining that the channel 62ch is not set to the tuner 11, the control CPU 20 returns to step ST13 in which it continues the processing.

Assuming that a transport stream having a transport stream id of 0x7EE2 associated with a channel UHF22ch can be received when the user pushes a search button of a remote controller in a state where preset groups as shown in FIGS. 5(a) and 5(b) are registered into the memory 19, the preset group number is changed into “1” since a transformer stream having the same transformer stream id is associated with remote_control_key_id of “6” in the preset group number “1”.

As can be seen from the above explanation, the search channel selection determining unit 20n, SI information analyzing unit 20d, information reading unit 20i, and preset group determining unit/setting unit 20e function as a searching means.

As mentioned above, the receiving apparatus according to this embodiment 2 searches for a preset group to which a transport stream having the same broadcast target area as a transport stream currently being received belongs, and registers, as preset information, SI information added to the transport stream currently being received into the preset group to which a transport stream having the same broadcast target area as the transport stream currently being received belongs. Therefore, the present embodiment offers an advantage of being able to carry out presetting very easily.

Furthermore, the receiving apparatus according to this embodiment 2 searches for a preset group to which a transport stream having the same transport stream name as the transport stream currently being received belongs, and, when determining that there exists a preset group to which a transport stream having the same transport stream name as the transport stream currently being received belongs, and selects a broadcasting station according to the preset group. Therefore, the present embodiment offers another advantage of being able to switch to a channel number having the same transport stream name automatically, and hence to select a broadcasting station while saving the user's time and effort.

### INDUSTRIAL APPLICABILITY

As mentioned above, the receiving apparatus in accordance with the present invention can select a receivable broadcasting station easily according to an area in which it is currently located, and is suitable for use in a moving object, such as a vehicle.

1. A receiving apparatus for receiving a broadcasting wave to which service information indicating at least a channel number, a transmission broadcasting station name, and a broadcast target area are added, characterized in that said receiving apparatus comprises:
a reception determining means for determining whether said broadcasting wave can be received in a predetermined region while changing said channel number;
a registration means for extracting said service information added to the broadcasting wave which is determined to be able to be received by said reception determining means, and for registering said service information, as preset information, into one preset group; and
a channel selecting means for selecting said broadcasting wave according to the preset information registered into said preset group.

2. The receiving apparatus according to claim 1, characterized in that the service information includes selection button numbers which are used for selecting channel numbers, respectively, and the registration means registers names of transmission broadcasting stations and a broadcast target area for these transmission broadcasting stations while associating them with said selection button numbers, respectively.

3. The receiving apparatus according to claim 2, characterized that said apparatus comprises a display control means for displaying a preset group list showing a list of preset groups, as well as broadcast target areas, and for, when a preset group is selected from this preset group list, displaying a preset group screen in which a plurality of broadcasting stations included in preset information associated with the selected preset group are associated with a plurality of selection button numbers, respectively.

4. The receiving apparatus according to claim 3, characterized in that when a selection button number is input, the channel selection means selects a channel number according to the input selection button number and a preset group number indicating the preset group and displayed on the preset group screen so as to select a broadcasting wave.

5. The receiving apparatus according to claim 1, characterized in that said apparatus has a searching means for searching for a preset group to which a broadcasting wave having a same broadcast target area as a broadcasting wave which said receiving apparatus is currently receiving belongs, and the registration means registers, as preset information, service information added to the broadcasting wave which said receiving apparatus is currently receiving into the preset group to which a broadcasting wave having the same broadcast target area as the broadcasting wave which said receiving apparatus is currently receiving belongs.

6. The receiving apparatus according to claim 1, characterized in that said apparatus has a searching means for searching for a preset group to which a broadcasting wave having a same transmission broadcasting station name as a broadcasting wave which said receiving apparatus is currently receiving belongs, and, when said searching means determines that there exists a preset group to which a broadcasting wave having a same transmission broadcasting station name as the broadcasting wave which said receiving apparatus is currently receiving belongs, the channel selection means selects a broadcasting wave according to said preset group.
